(19) United States
(12) Patent Application Publication
(10) Pub. No.: US 2019/0107324 A1
(43) Pub. Date: Apr. 11, 2019

(54) PROCESS AND FACILITY FOR COOLING THE NECK OF BOTTLES USING A SOLID HEAT-TRANSFER MEDIUM

(71) Applicant: L'Air Liquide, Societe Anonyme pour I'Etude et I'Exploitation des Procedes Georges Claude, Paris (FR)

(72) Inventors: Franck Cousin, Saint Brevin Les Pins (FR); Helene Gensse, Paris (FR)

(73) Assignee: L'Air Liquide, Societe Anonyme pour I'Etude et I'Exploitation des Procedes Georges Claude, Paris (FR)

(21) Appl. No.: 16/154,994

(22) Filed: Oct. 9, 2018

(30) Foreign Application Priority Data
Oct. 11, 2017 (FR) FR 1701056

(51) Int. Cl. F25D 31/00; C12G 1/08; F25D 3/11; F25D 29/00

(52) U.S. Cl. CPC F25D 31/007; C12G 1/08; F25D 3/11; F25D 29/001; F25D 2700/121; F25D 2331/803; F25D 2300/00; F25D 2303/085; F25D 2303/0846; F25D 29/005

(57) ABSTRACT

The invention relates to a process for cooling the neck of bottles, wherein the neck of the bottle, positioned in the inverted position, is submerged in a mass of a solid heat-transfer medium, for example copper shot, which mass is cooled using a cryogenic fluid, for example liquid nitrogen, or else liquid CO₂ or else a mixture of such fluids.

### CROSS-REFERENCE TO RELATED APPLICATIONS

This application claims the benefit of priority under 35 U.S.C. § 119 (a) and (b) to French patent application No. FR 1 701 056, filed Oct. 11, 2017, the entire contents of which are incorporated herein by reference.

### BACKGROUND

### Field of the Invention

The present invention relates to the wine-making industry and most particularly to processes for cooling necks of bottles. These processes are employed in the wine-producing field according to the “champenoise” (champagne) method in order to prepare bottles in the operation referred to as “disgorging”.

### Related Art

It should be recalled that the champagne method essentially consists in causing, after a first, alcoholic, fermentation on the barrel, and optionally a second, “malolactic”, fermentation in the bottle, a second or even third fermentation by adding fermenting agents to the wine which will gradually convert the sugar into alcohol and carbon dioxide gas. After a period of ageing, the fermentation produced a deposit which must be removed; this is carried out during an operation referred to as “disgorging”.

In order to prevent as much wine as possible from escaping during this disgorging operation, which is performed on upside-down bottles, and in order to prevent the deposit from going back into the bottle, according to one of the methods practised, the neck of the bottle is cooled by submerging it in a bath of coolant liquid until a block of ice is formed which contains the particles of the deposit; it is then necessary to merely remove the block of ice containing the deposit, with the wine removed in ice form being subsequently replaced.

There is currently essentially a single process for mechanically forming the block of ice in a bottle, which consists in submerging the neck of the bottle in a bath of brine or glycol, as is described in documents FR-2.578.037 and FR-2.854.450, for example. This process has drawbacks in the sense that handling glycol is relatively unpleasant, and that the product is relatively incompatible with a food-producing environment.

In order to overcome these drawbacks, document FR-2 538.885 proposed the use of a different, colder, coolant liquid, namely liquid nitrogen, especially in order to accelerate the cooling step. However, the use of liquid nitrogen has a major drawback, namely that of causing glass bottles to shatter when they come into contact with it. Thus, the machine described in this document has not been used very much in practice.

Other works have proposed using a stream of air, which will have been cooled beforehand, but the energy required for the cooling and the formation of frost on the bottle make this solution relatively unsatisfactory.

Moreover, it has been proposed to use gels at very low temperature, but this solution must be followed by thorough cleaning of the necks of the bottles, constituting a prohibitive drawback.

### SUMMARY OF THE INVENTION

One of the aims of the present invention is therefore to propose a novel solution for cooling necks of bottles.

As will be seen in more detail below, the present invention proposes using a solid heat-transfer medium (for example copper shot of approximately 2 mm, but shavings of other metals may also be envisaged, or else other solids having beneficial heat transfer properties), which is cooled with a cryogenic fluid, for example liquid nitrogen or liquid CO₂ or a mixture of such fluids.

Using such a solid heat-transfer agent offers a highly beneficial solution since it makes it possible to solve the problems of cleaning the bottles after the disgorging operation, which cleaning was necessary in certain methods of the prior art.

The heat-transfer medium is cooled by a cryogen, and control of the temperature of the heat-transfer agent makes it possible to manage the temperature obtained on the neck of the bottles.

This system is moreover entirely compatible with commonly employed food and environmental standards since, as has been said, it is not required to clean the bottles after freezing the necks, and it does not involve discharging waste water or pollutants such as glycol.

The present invention therefore relates to a process for cooling the neck of bottles, wherein the neck of the bottle, positioned in the inverted position, is submerged in a mass of a solid heat-transfer medium, for example copper shot, which mass is cooled using a cryogenic fluid, for example liquid nitrogen, or else liquid CO₂ or a mixture of such fluids.

The process may be carried out continuously or batchwise: in the case of continuous operation for example using a conveyor, in a structure which may be likened to a tunnel, and in the case of batch mode for example by means of a rotating table.

### BRIEF DESCRIPTION OF THE FIGURES

FIG. 1 is a partial schematic of an embodiment of a facility for performing the method of the invention.

### DETAILED DESCRIPTION OF THE INVENTION

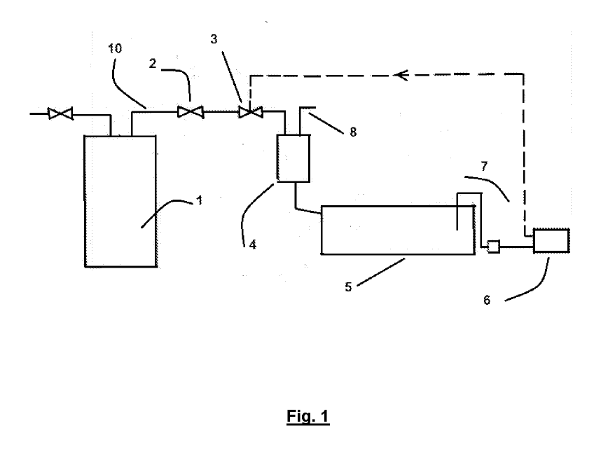

Other features and advantages of the present invention will be more clearly apparent from the following description, given by way of wholly nonlimiting illustration and made in relation to the appended FIG. 1 which is a partial schematic view of a facility making it possible to carry out the invention.

The following elements can be seen in FIG. 1:
there is a store 1 of cryogenic fluid, for example in this case liquid nitrogen, from which store emerges a fluid distribution line 10 equipped with a shut-off valve 2 and a solenoid valve 3 which can be driven by a regulator 6;
the fluid preferentially travels via a phase separator 4, enabling the downstream supply of a substantially clearly defined liquid (limiting the proportion of gas phase);
the fluid originating from the separator 4 then supplies a tank 5, in which is deposited a mass of a solid heat-transfer medium, for example in this case copper shot, but which is cooled by the cryogen, for example by spraying;
there is a system 7 for measuring the temperature of the shot, and also a regulating system 6 making it possible, depending on the temperature measurement result, to modify (3) the conditions for supplying cryogen to the tank;
by way of illustration, it is possible to envisage a probe present in the tank, especially when the tank is sufficiently small and therefore the temperature measured in this way is representative; it is also possible to envisage larger tanks, in which it is then preferable to cause the shot to circulate (for example by means of an endless screw coupled to a vibratory system).
the bottles are then transported (by means not shown in the FIGURE for example by a conveyor in a tunnel-type structure), positioned in the inverted position, in order for the neck of each bottle to be cooled to be submerged in the cooled solid heat-transfer medium for a sufficient period of time to obtain the freezing of the deposit which must be removed (disgorging).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A process for cooling a neck of a bottle, comprising the steps of:
cooling a mass of a solid heat-transfer medium comprising metal shavings with a cryogenic fluid; and
submerged the neck of the bottle, while positioned in an inverted position, in the cooled mass.

2. The process to claim 1, wherein a temperature of the solid heat-transfer medium is measured, and depending on a result of the temperature measurement, conditions for supplying the cryogenic fluid to the mass of the solid heat-transfer medium are modified.

3. The process of claim 1, wherein the metal shavings are copper shot.

4. The process of claim 1, wherein the cryogenic fluid is selected from liquid nitrogen, liquid CO₂, and mixtures thereof.

5. A facility for cooling the neck of bottles, which comprises:
a reserve of a solid heat-transfer medium consisting of metal shavings, for example copper shot, contained in a tank;
a store of cryogenic fluid, for example liquid nitrogen or liquid CO₂;
a fluid distribution line, connected at the upstream part thereof to said store, and at the downstream part thereof to said tank, which line is equipped with a control valve;
a regulator capable of retroacting on said control valve on the basis of a measurement of the temperature of the solid medium present in the tank,
means making it possible to transport the bottles, positioned in the inverted position, in order to bring the neck of each bottle to be cooled within the solid heat-transfer medium which has been cooled using said cryogenic fluid.
